(19) United States
(12) Patent Application Publication
(10) Pub. No.: US 2025/0091913 A1
(43) Pub. Date: Mar. 20, 2025

(54) APPARATUS AND METHODS FOR SIMULTANEOUS INDUCTION OF MULTIPLE BIPOLAR ELECTRODES WITH SHARED FEEDER ELECTRODE PAIRS

(71) Applicant: ELATEQ, INC., AMHERST, MA (US)

(72) Inventor: Ljiljana Rajic, Amherst, MA (US)

(73) Assignee: ELATEQ, INC., AMHERST, MA (US)

(21) Appl. No.: 18/889,119

(22) Filed: Sep. 18, 2024

Related U.S. Application Data
(60) Provisional application No. 63/538,895, filed on Sep. 18, 2023.

(51) Int. Cl. C02F 1/461

(52) U.S. Cl. CPC C02F 1/46109; C02F 2001/46133; C02F 2001/46152; C02F 2201/4616; C02F 2201/4618

(57) ABSTRACT

A system for electrochemically enhanced fluid filtration, the system including at least one feeder anode having an inner anode plate and an outer anode plate and at least one feeder cathode having an inner cathode plate and an outer cathode plate. The system further includes an outer bipolar electrode located between the inner anode plate and the outer anode plate and between the inner cathode plate and the outer cathode plate and an inner bipolar electrode located between the inner anode plate and the inner cathode plate.

### CROSS-REFERENCE TO RELATED APPLICATIONS

This application claims priority to U.S. Provisional Application No. 63/464,335 filed on Sep. 18, 2023, which is herein incorporated by reference in its entirety.

### BACKGROUND

### Technical Field

Embodiments of the invention relate generally to techniques for fluid processing and, more specifically, to systems and methods for electrochemically enhanced water filtration.

### Discussion of Art

Electrochemical and electrochemically induced processes are widely used in water processing, from contaminants removal and desalination (capacitive deionization) to metal plating and valuable minerals extraction, to name a few uses. These electrochemical processes operate without chemical addition, allowing automatic control and manipulation of water chemistry, scalability, and use of alternative power sources. Specifically, since the first studies in the late 1960s, bipolar electrochemistry has been studied and employed in various applications as it offers various system designs and operation flexibility, and energy savings.

Bipolar electrochemical systems include feeder or driving electrodes (single or double pair) and conductive material (single or multiple) placed in the electric field between electrodes. This induces oppositely directed faradaic reactions (reduction/oxidation) at the cathodic and anodic poles of the bipolar or wireless electrodes (Fosdick et al., 2010, 2013). The potential difference between the solution and the bipolar electrode is highest at the extremities, and so is the potential difference for driving the faradaic processes. This concept offers flexibility in design since wireless electrodes are not connected to the power source allowing for manipulation of the reactions on the bipolar electrode by simply adjusting the electric field and/or bipolar electrode length.

Among others, bipolar electrochemical systems have been studied and used for water treatment, e.g., (U.S. patent Ser. No. 11/535,533B2); (Andrés Garcia et al., 2018); (Boinpally et al., 2023); (Thompson et al., 2021); metal plating, with especially interesting applications for manufacturing of fuel cell membranes, (Ijaodola et al. 2018), lab-on-a-chip systems for various uses, (Mwanza & Ding, 2023); (Sridhar et al., 2022), and other uses (U.S. Pat. No. 3,884,792A).

However, the significance of geometric aspects and potential enhancements of bipolar systems and their employment has not been extensively explored. For example, in bipolar systems that utilize tubular, rod-like, or bipolar electrodes with external connections, or split bipolar electrodes (Kazem-Ghamsari & Alexander, 2023; Sakagami et al., 2022), as depicted in FIG. 1D, FIG. 1E, and FIG. 1F, improvements are necessary. For example, in known systems that utilize concentric bipolar electrodes (tubular), feeder electrodes are placed in the central and outer sections of the electrode (U.S. Pat. No. 3,873,438). In such systems, simple multiplication of the conductive material between the feeder electrodes employed for, e.g., electrocoagulation, is not possible. Such an approach would be challenging to maintain the same potential difference between the solution and electrodes' poles as it depends on the distance between feeder electrodes, bipolar electrode length, and applied electric field.

### BRIEF DESCRIPTION

In embodiments, the apparatus and methods described herein have been developed to allow the flexibility of bipolar electrodes by using different materials for the same bipolar electrode to induce various reactions and/or increase the reactions' efficiency at bipolar electrodes using shared feeder electrode pairs, e.g., electrodes sharing the same DC power source. In embodiments, the novel application introduces the solution by increasing the bipolar electrode surface area using the same amount of conductive material while enabling the use of different materials using shared feeder electrode pairs.

In an aspect of the invention, a system for electrochemically enhanced fluid filtration, the system includes at least one feeder anode having an inner anode plate and an outer anode plate, and at least one feeder cathode having an inner cathode plate and an outer cathode plate. The system further includes an outer bipolar electrode located between the inner anode plate and the outer anode plate and between the inner cathode plate and the outer cathode plate, and an inner bipolar electrode located between the inner anode plate and the inner cathode plate.

In an embodiment, the system further includes a power source electrically coupled to the at least one feeder anode and the at least one feeder cathode.

In an embodiment, the outer bipolar electrode is manufactured from a first material and the inner bipolar electrode is manufactured from a second material different from the first material.

In an embodiment, the first material and/or the second material are selected from carbon-based materials, graphite-based materials, stainless steel, metals, alloys, and combinations thereof.

In an embodiment, the at least one feeder anode and the at least one feeder cathode of manufactured from TiMMO.

In an embodiment, the inner anode plate has a different construction from the outer anode plate.

In an embodiment, the inner cathode plate has a different construction from the outer cathode plate.

In an embodiment, the outer bipolar electrode is cylindrical with an open interior.

In an embodiment, the inner bipolar electrode is either tubular with an open interior or a solid cylinder and is located within the open interior of the outer bipolar electrode.

In an embodiment, the at least one feeder anode includes two feeder anodes and the at least one feeder cathode includes two feeder cathodes and wherein a first anode of the two feeder anodes and a first cathode of the two feeder cathodes are electrically connected to a first power source and wherein a second anode of the two feeder anodes and a second cathode of the two feeder cathodes are electrically connected to a second power source.

In an embodiment, the system further includes an external housing and wherein the at least one feeder anode and the at least one feeder cathode are secured to the housing via fasteners and the fasteners are electrically connected to a power source.

### BRIEF DESCRIPTION OF THE DRAWINGS

The present invention will be better understood by reading the following description of non-limiting embodiments, with reference to the attached drawings, wherein below:

FIG. 1A is a schematic diagram of a system according to an embodiment of the invention that illustrates the polarization of various modes of bipolar electrodes that utilize a sectioned outer tubular electrode and an inner rod-like bipolar electrode in a one-dimensional (1D) electric field;

FIG. 1B is a schematic diagram of a system according to an embodiment of the invention that utilizes tubular sectioned bipolar electrodes;

FIG. 1C is a schematic diagram of a system according to an embodiment of the invention that utilizes sectioned planar bipolar electrodes composed with an external connection;

FIG. 1D is a schematic diagram that illustrates a known single rod-like bipolar electrode;

FIG. 1E is a schematic diagram that illustrates a known single tubular bipolar electrode;

FIG. 1F is a schematic diagram that illustrates a known split bipolar electrode system;

FIG. 1G is a schematic cross-section of the system of FIG. 1C within a housing.

FIG. 2 is a top view of a system according to an embodiment of the invention with a 2D electric field;

FIG. 3 is an illustration of copper mesh bipolar electrodes, when employed in a system of FIG. 1B with applied voltage: 5 V; electrolyte: 1.2 mS/cm Na₂SO₄ solution;

FIG. 4A is a bar chart illustrating an improvement in Methylene Blue removal efficiency (including power consumption) according to embodiments of the invention;

FIG. 4B is a bar chart illustrating an improvement in Methylene Blue removal efficiency (including power consumption) according to embodiments of the invention;

FIG. 5 is a bar chart illustrating an improvement in Hydrogen Peroxide generation efficiency (including power consumption) according to embodiments of the invention;

FIG. 6 is a bar chart illustrating an improvement in TDS removal efficiency (including power consumption) according to embodiments of the invention.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

Additionally, embodiments of the inventive system are applicable in areas of water processing, including but not limited to contaminants removal, salt removal (desalination), targeted mineral extraction, and metal plating. Certain embodiments may be suitable for use with/applicable to other types of filtration processes involving liquids other than water.

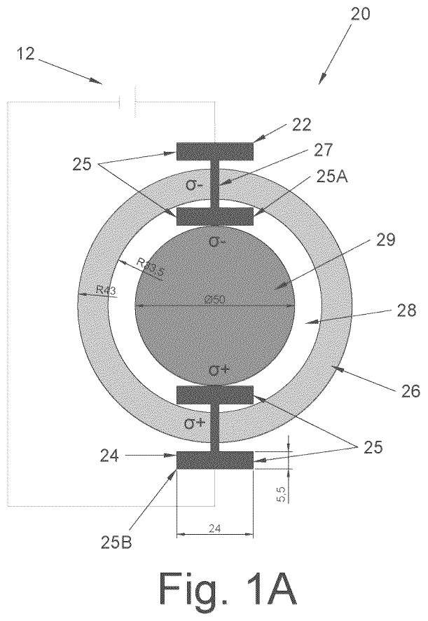

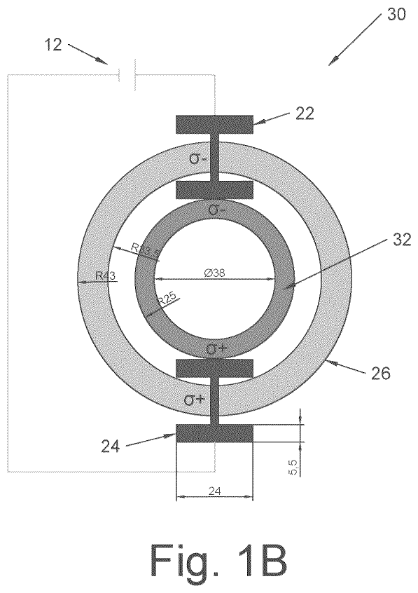

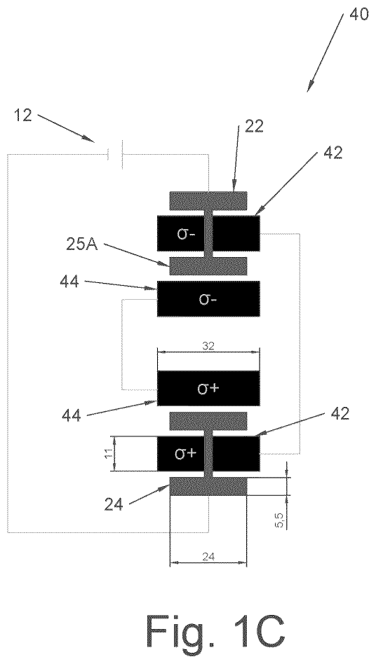

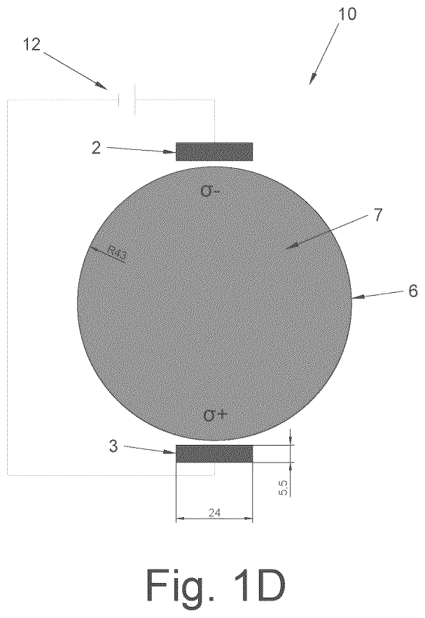

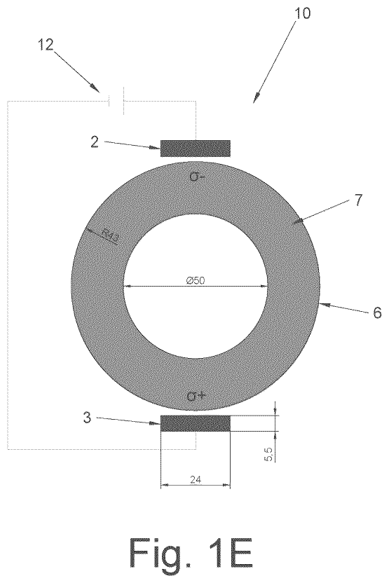

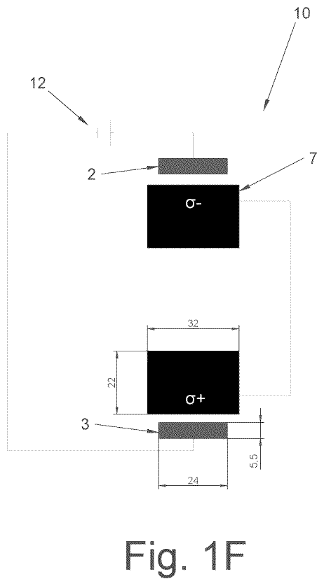

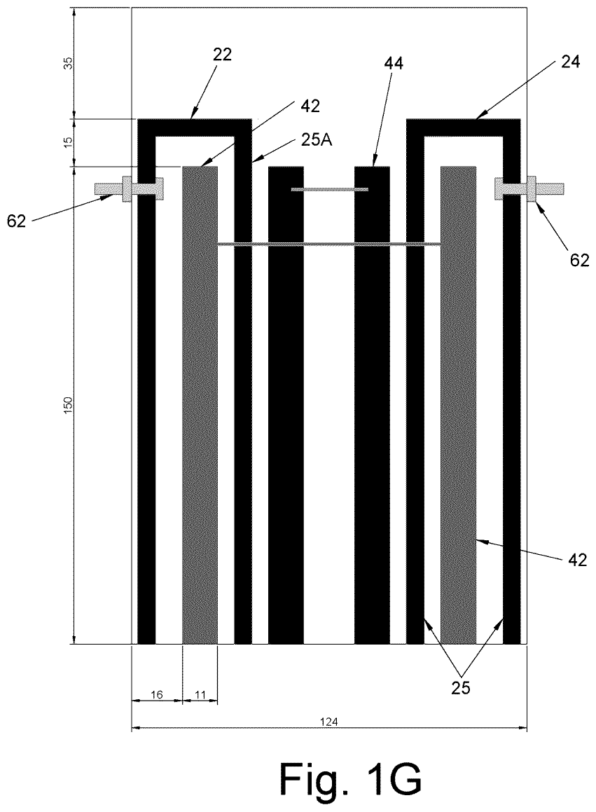

Referring to FIGS. 1D-1F, known bipolar electrode configurations 20 are depicted. More specifically, FIG. 1D illustrates a single rod-like bipolar electrode, FIG. 1E depicts a known tubular design, and FIG. 1F illustrates a known split bipolar electrode. These known systems include a DC power source 12 that is electrically connected to a single feeder anode 2 and feeder cathode 3 which are adjacent to a single bipolar electrode 7, which may be in the form of a single rod or tube, or an electrically connected split electrode (FIG. 1F). In such systems, multiplication of the conductive material, e.g., 7, between the feeder electrodes 2, 3, employed for, for example, electrocoagulation, is not possible as the polarization would not be induced or the interfacial potential difference would be different for each section.

FIG. 1A is a simplified schematic top-down view of a system for electrochemically enhanced water filtration in accordance with an embodiment of the invention. As shown, the system 20 includes a feeder anode 22 and a feeder cathode 24. The feeder anode 22 and feeder cathode 24 are electrically connected to a single power source (DC) 12. The system 20 further includes a tubular outer bipolar electrode 26 having an open interior 28, and a solid, cylindrical inner bipolar electrode 29. In embodiments, the outer bipolar electrode and/or the inner bipolar electrode may include a layer of a permeable, electrically insulating material.

The feeder anode 22 and feeder cathode 24 have two plates or leg portions 25 (e.g., inner and outer plates/leg portions) and a connector portion 27 that is substantially perpendicular to the two leg portions 25(FIG. 1G) joining the plates/leg portions together. In embodiments, the plates/leg portions 25 and connector portion 27 are made from the same material, i.e., titanium-based mixed metal oxide or TiMMO. In embodiments, the connector portion 27 may have a reduced width as compared to the plates/leg portions 25 to, e.g., reduce weight, though embodiments are not limited in this regard.

The plates/leg portions 25 of the feeder anode 22 and feeder cathode 24 extend longitudinally on opposite sides of the tubular outer bipolar electrode 26. The inner bipolar electrode 29 is adjacent to inner plates/legs 25A of the leg portions 25 of the feeder anode 22 and feeder cathode 24. The feeder anode 22 and feeder cathode 24 are positioned substantially opposite from one another on the circumference of the outer bipolar electrode 26. This configuration results in two separate bipolar electrodes that can use different materials for the inner and outer bipolar electrodes 29, 26, which impart different properties and functionality. In this way, the system 20 provides functionality and versatility that known systems do not.

In embodiments, the feeder anode 22 and feeder cathode 24 are manufactured from titanium-based mixed metal oxide (TiMMO) mesh. In a specific embodiment, the leg portions 16 have a width of 24 mm and a thickness of 5.5 mm, though embodiments are not limited in this regard.

The outer and inner bipolar electrodes 26, 29 may be manufactured from any conductive material, such as, but not limited to, carbon-based materials, graphite-based materials, various metals and alloys such as stainless steel, copper, nickel, etc., and other conductive materials. Importantly, as previously mentioned, the outer and inner bipolar electrodes 26, 29 can be composed of different materials at the same time. In certain embodiments, the system may be modular, in that it the inner and/or outer electrodes may be removed/replaced by a user to alter the functionality/end use of the system as desired.

In embodiments, the outer bipolar electrode 26 (or the inner 29) may be manufactured from a first material and the inner bipolar electrode 29 (or the outer 26) may be manufactured from a second material that is different from the first material.

Referring now to FIG. 1B another embodiment of the system is depicted. In this embodiment, the system 40 includes the same components of system 20 of FIG. 1A, with the exception of a tubular inner bipolar electrode 32.

Another embodiment is depicted in FIG. 1C. In this embodiment, the system 40 does not utilize cylindrical or tubular inner and outer bipolar electrodes but uses four sectioned planar electrodes. As shown, these include a pair of electrically connected outer planar electrodes 42 and a pair of electrically connected inner planar electrodes 44. This system 40 may use the same feeder anode 22 and feeder cathode 24 which are electrically connected to a power source 12 (DC).

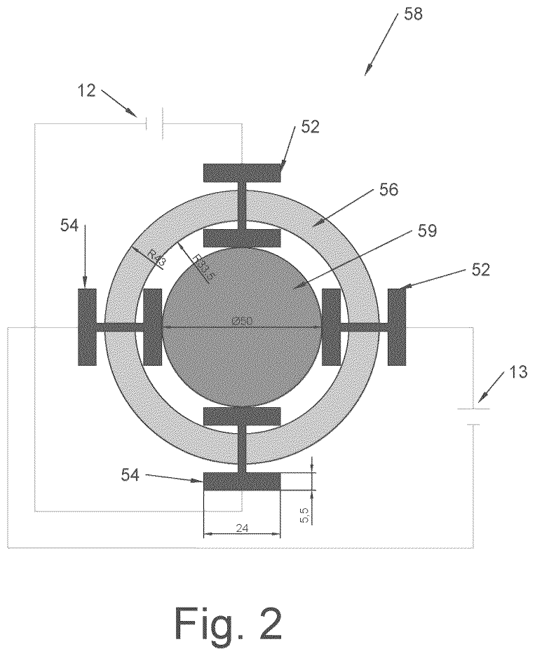

Referring to FIG. 1G, which depicts a sectioned schematic side view of the system 40 of FIG. 1C, the components of the systems of FIGS. 1A-1C (and those of FIG. 2) may be located within an outer housing 60 of, for example, a plug-flow electrochemical reactor. Of course, as will be appreciated, embodiments may be configured for use with various reactors/housings/systems including batch and continuous systems and are not limited in this regard.

As shown, the feeder anode 22 and feeder cathode 24 are connected to the outer housing 60 via fasteners 62. The fasteners 62 are, in embodiments, titanium (e.g., Ti Grade 2) screws which are electrically connected to the power source (DC) and serve as a connection between the feeder anode 22 and cathode 24 and one or more power sources. As depicted, the outer bipolar electrode pair 42 is located between the leg portions 25 of the feeder anode 22 and feeder cathode 24. The inner bipolar electrode pair 44 is adjacent the inner leg portions 25A of the feeder anode 22 and feeder cathode 24. The bipolar electrode pairs 42, 44, may be secured to the to a bottom surface of a batch or flow through cell via a variety of attachment means.

The embodiments of FIGS. 1A-1C and FIG. 1G operate in a one-dimensional (1D) electric field. The embodiment of FIG. 2 operates in a two-dimensional (2D) electric field. More specifically, the system 50 of FIG. 2, includes two feeder anodes 52 and feeder anodes 54 that are opposite one another and evenly spaced about a circumference of the cylindrical outer bipolar electrode 56. In this embodiment, one set of feeder anodes and cathodes 52, 54 is connected to a first DC power source 12 and the other set is electrically connected to a second DC power source 13. In certain embodiments, the applied 2D electric field is generated by two or more voltages. In the embodiment of FIG. 2, the first and the second pair of feeder cathode/anodes are collectively operative to apply a 2D electric field in at least one of a horizontal direction and a vertical direction with respect to, for example, a chamber of a plug-flow electrochemical cell in which the components are located.

Moreover, the systems of FIGS. 1A-1C and 1G, allow for the use of different TiMMO constructions (e.g., solid, porous, or mesh) for each plate/leg portion of the planar feeder cathode and feeder anode, leading to flexibility in inducting different reactions at each polarized side of the bipolar electrodes. This is in addition to the flexibility provided by the ability to use differing conductive materials for the inner and outer bipolar electrodes. As noted previously, embodiments of the invention system apply to one-dimensional (1D) or two-dimensional (2D) electric fields, as shown in FIG. 2, and can be introduced for both batch and flow-through systems.

Through the above systems, the applied voltage across each section is the same. Since the ratio between feeder electrode length and bipolar electrode length is maintained within 90%, the same interfacial potential difference between all bipolar electrodes and the solution is achieved for each bipolar electrode section.

### Experimental Setup

The following tests were conducted to confirm the increase in efficiency when systems according to embodiments of the invention are utilized (Table 1). The materials' specific characteristics and modifications used are not disclosed here, but the materials with the same characteristics were compared to assess efficiency. The tests aimed to assess the percentage of improvement of the efficiencies using embodiments of the inventive system for the specific model contaminants removal or generation of selected chemical species in aqueous solutions.

The following conditions were maintained in the tests below:

Electrolyte: Sodium sulfate at 1.2 mS/cm. A6 and A7 were run with the same electrolyte at 3.45 mS/cm.

Electrolyte volume: 100 mL.

Feeder electrode: TiMMO (2.54 cm width, 4 cm immersed in electrolyte).

Cell type: batch (no mixing).

Cell dimensions: diam. 6 cm, length 8 cm.

Outer electrode: diam. 4.5 cm.

Inner electrode: diam. 2.5 cm.

DC setup: constant voltage (CV) and constant current (CC) modes were applied. The voltage in CC mode in all tests was >5 V. CV1 tests were conducted under 9V. CV2 tests were conducted under 2.2 V.

Test duration: 5 minutes.

TABLE 1

| | Bipolar | | Target | | |
|---|---|---|---|---|---|
| Exper- | electrode | | contam- | DC | |
| iment | material | Setup | inant | setup | Goal |
| T1 | Graphite | FIG. 1E | Methylene | CV1 | Organics removal |
| | felt | | blue | | improvement/ |
| T2 | Graphite | FIG. 1B | Methylene | CV1 | Electro-Fenton-like |
| | felt | | blue | | reaction |
| T3 | Graphite | FIG. 1B | Methylene | CC | improvement |
| | felt | | blue | | |
| A1 | Activated | FIG. 1A | Methylene | CC | |
| | carbon | | blue | | |
| A2 | Activated | FIG. 1D | Methylene | CC | |
| | carbon | | blue | | |
| AP1 | Graphite | FIG. 1B | H₂O₂ | CC | Electro-Fenton-like |
| | felt | | formation | | reaction |
| AP2 | Graphite | FIG. 1E | H₂O₂ | CC | improvement |
| | felt | | formation | | (peroxide formation |
| | | | | | is the first step) |
| A3 | Activated | FIG. 1A | Nickel | CV2 | Metals removal |
| | carbon | | | | improvement |
| A5 | Activated | FIG. 1D | Nickel | CV2 | |
| | carbon | | | | |
| A6 | Graphite | FIG. 1B | Total | CV22 | Desalination |
| | felt | | dissolved | | improvement |
| | | | solids, TDS | | |
| A7 | Graphite | FIG. 1E | TDS | CV2 | |
| | felt | | | | |

### Results

### The Proof-Of-Concept Rapid Testing

Embodiments of the inventive system were preliminary tested using a batch reactor (cell dimensions: diameter—6 cm, length—8 cm) and sodium sulfate electrolyte with 1.2 mS/cm conductivity. The systems shown in FIGS. 1B and 1E were tested using graphite felt electrodes, and the constant voltage applied to feeder electrodes was 12 V. The voltage applied was to ensure the Faradaic reactions at the poles of all bipolar electrodes. The oxygen and hydrogen formation due to water electrolysis at anodic and cathodic poles of all bipolar electrodes in all systems of FIGS. 1A-1E were observed and confirmed during the tests. Without the extended feeder electrode facing the inner electrodes, no bubbles were observed at either pole of the inner bipolar electrodes.

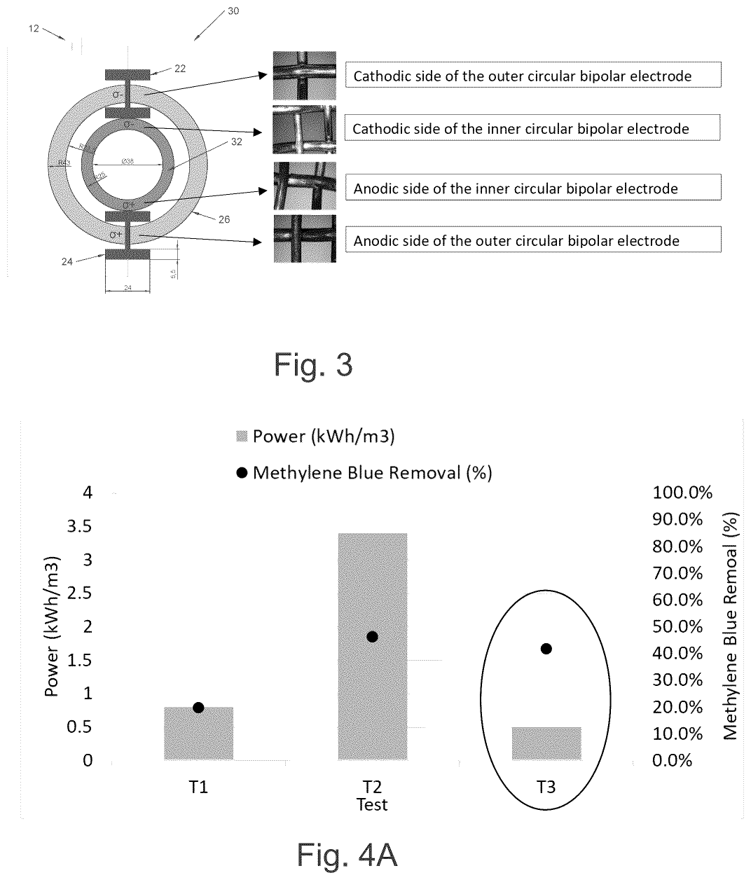

Further, rapid proof-of-concept testing was also conducted using copper mesh as both outer and inner bipolar electrodes, as shown in FIG. 3. After the 5-minute test, the polarization of both bipolar electrodes was evident as the anodic poles of both the inner and outer electrodes showed significant corrosion (FIG. 3) in addition to bubble generation. Without the extended feeder electrode facing the inner electrodes, no bubbles were observed at either pole of the inner bipolar electrodes, and no corrosion was evident at the anodic poles.

Moreover, embodiments of the invention were tested with a real water sample from the nickel electrolyte used for plating, which contained 14.2 ppm of nickel. Utilizing the electrochemical system as per FIG. 1D (with 2 D electric field) and the system depicted in FIG. 2, the final achieved nickel concentration was 2.8 pm under 2.77 Wh and 2.8 ppm under 3.60 Wh, respectively, indicating an energy savings of 23% using novel concept to achieve the same removal efficiency.

### Organics Removal

The processes induced in the tested electrochemical systems were proven to induce electro-Fenton-like reactions (U.S. patent Ser. No. 11/535,533B2, which is hereby incorporated by reference in its entirety), which lead to hydroxyl radicals or ^{∘}OH production. ^{∘}OHs are responsible for the degradation of organic molecules, i.e., Methylene Blue, and this process is the primary removal mechanism in the conducted tests.

The electro-Fenton-like reactions are cost-effective indirect electrochemical oxidation processes where reactive oxygen species such as ^{∘}OH are generated in the bulk solution. The most promising processes are electro-Fenton and Fenton-like reactions involving in situ cathodic electro-generation of H₂O₂ via two-electron oxygen reduction (Eq. 1), further activated to ^{∘}OH (Brillas & Garcia-Segura, 2020; Poza-Nogueiras et al., 2018; Yu et al., 2015).

$${O}_{2} + 2 {H}^{+} + 2 {e}^{-} \to {H}_{2} {O}_{2} \qquad Eq . 1$$

Of particular interest among the indirect electrochemical oxidation processes is a heterogeneous electro-Fenton-like reaction where H₂O₂ is generated by a catalyst-free cathode via two-electron oxygen cathode reduction and activated in the absence of Fe(II). Compared to other electro-Fenton processes where no external oxygen supply is needed (utilizes anodic oxygen), this electro-Fenton-like process also operates under neutral pH (Zhou et al., 2018, 2019, U.S. patent Ser. No. 11/535,533B2).

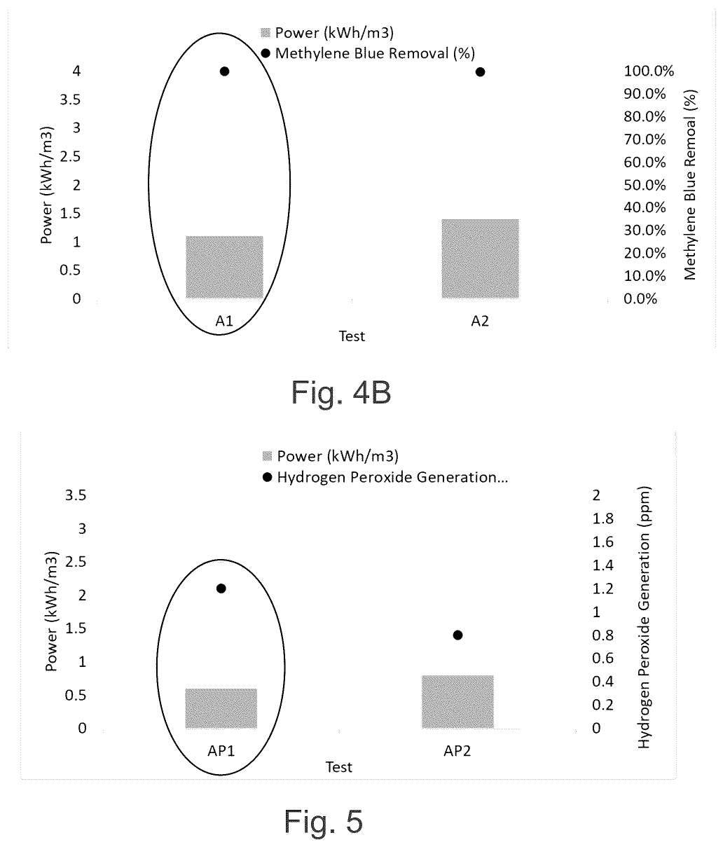

As shown in FIGS. 4A and 4B, embodiments of the invention significantly improve Methylene Blue removal efficiency and lower power consumption compared to single bipolar electrode modes. This is observed when graphite felt and activated carbon bipolar electrodes are used, as depicted in FIG. 1A and FIG. 1B, respectively, versus their employment in known systems of FIG. 1D and FIG. 1E. The removal efficiency of Methylene Blue doubled while power consumption decreased by an average of 25% across all tests due to increased conductivity of the inventive systems when constant current mode was employed. During the constant voltage test, T2, the current increased four times compared to T1, which is caused by the induction of multiple reaction sites at outer and inner bipolar electrodes.

The increased removal efficiency of the inventive systems is related to an induction of additional anodic and cathodic poles of the inner bipolar electrode that support the same electro-Fenton-like reactions, mainly hydrogen peroxide generation and activation at the cathodic pole. Dissolved oxygen is necessary for the generation of hydrogen peroxide (Eq. 1), and the inventive system aids in hydrogen peroxide production as it also allows the in-situ oxygen production at the feeder anodes in the vicinity of both cathodic poles (outer and inner bipolar electrodes).

As the first step in an electro-Fenton-like reaction, the impact of the inventive system solely on hydrogen peroxide generation (Eq. 1) was tested (FIG. 5). Power consumption decreased by an average of 20%, while the generation of hydrogen peroxide increased by 30%. The low hydrogen peroxide values are caused by the absence of mixing in the electrochemical cell.

TDS removal

Besides inducing processes for advanced oxidation, tested electrochemical setups can operate under conditions that support capacitive deionization or CDI. This process is utilized for total dissolved solids (TDS) removal or desalination. The CDI mechanism is the electrosorption of the salt ions on the electrodes, including adsorption due to the formation of electric double-layer (EDL) and salt interaction ions with carbon electrodes' functional groups.

The electrodes capture salt ions and/or charged particles upon applying a direct current or voltage across the cell (charging step) under a cell potential of <1.2 V to prevent both Faradaic decomposition of water and chlorine evolution, although some applications do rely on Faradaic processes. The induction of these processes in the bipolar systems was previously demonstrated in U.S. patent Ser. No. 11/535,533B2 and Bian et al. 2015 (Bian et al., 2015).

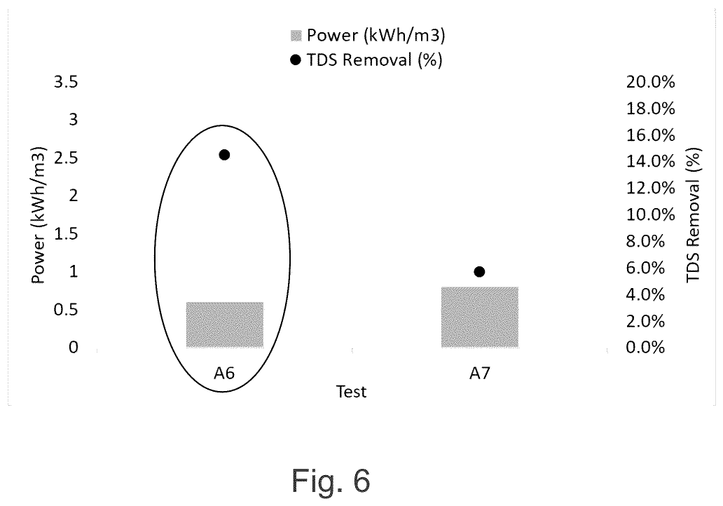

The electrodes' ion adsorption capacity is a key parameter affecting the CDI's desalination performance and the inventive systems target the increase of the electrode adsorption capacity by multiplying the electrode surface area. As shown in FIG. 6, TDS removal efficiency is significantly increased in embodiments of the inventive system, which, as described above, is directly related to additional anodic and cathodic poles of the inner bipolar electrode and the availability of larger surface areas of the induced bipolar electrodes.

The TDS removal efficiency increased nearly three times, and power consumption decreased by 30%. Further testing involved Ni removal as a model target metal using the abovementioned process. The initial Ni value was 5,400 mg/L, as found in nickel-plating spent electrolytes. The removal of Ni increased from 10.4% using the conventional bipolar system as in A2 to 44.5% achieved by the inventive system as A1 (FIG. 1A).

While the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

1. A system for electrochemically enhanced fluid filtration, the system comprising:
at least one feeder anode having an inner anode plate and an outer anode plate;
at least one feeder cathode having an inner cathode plate and an outer cathode plate;
an outer bipolar electrode located between the inner anode plate and the outer anode plate and between the inner cathode plate and the outer cathode plate; and
an inner bipolar electrode located between the inner anode plate and the inner cathode plate.

2. The system of claim 1 further comprising:
a power source electrically coupled to the at least one feeder anode and the at least one feeder cathode.

3. The system of claim 1 wherein the outer bipolar electrode is manufactured from a first material and the inner bipolar electrode is manufactured from a second material different from the first material.

4. The system of claim 3 wherein the first material and the second material are selected from carbon-based materials, graphite-based materials, stainless steel, metals, alloys, and combinations thereof.

5. The system of claim 1 wherein the at least one feeder anode and the at least one feeder cathode are of manufactured from TiMMO.

6. The system of claim 1 wherein the inner anode plate has a different construction from the the outer anode plate.

7. The system of claim 1 wherein the inner cathode plate has a different construction from the outer cathode plate.

8. The system of claim 1 wherein the outer bipolar electrode is tubular with an open interior.

9. The system of claim 8 wherein the inner bipolar electrode is either tubular with an open interior or a solid cylinder and is located within the open interior of the outer bipolar electrode.

10. The system of claim 1 wherein the at least one feeder anode includes two feeder anodes and the at least one feeder cathode includes two feeder cathodes;
wherein a first anode of the two feeder anodes and a first cathode of the two feeder cathodes are electrically connected to a first power source;
wherein a second anode of the two feeder anodes and a second cathode of the two feeder cathodes are electrically connected to a second power source.

11. The system of claim 1 further comprising:
an external housing; and
wherein the at least one feeder anode and the at least one feeder cathode are secured to the housing via fasteners;
wherein the fasteners are electrically connected to a power source.

12. The system of claim 1 wherein inner bipolar electrode and/or the outer bipolar electrode are selected from carbon-based materials, graphite-based materials, stainless steel, metals, alloys, and combinations thereof.
